(19) United States
(12) Patent Application Publication
(10) Pub. No.: US 2013/0198023 A1
(43) Pub. Date: Aug. 1, 2013

(54) Power Providing Managing Unit

(71) Applicants: Ibtissam El Khayat, Glons (BE); Heiko Perkuhn, Bonn (DE)

(72) Inventors: Ibtissam El Khayat, Glons (BE); Heiko Perkuhn, Bonn (DE)

(21) Appl. No.: 13/721,995

(22) Filed: Dec. 20, 2012

(30) Foreign Application Priority Data
Dec. 21, 2011 (EP) 1195027.5

(51) Int. Cl. G06Q 30/06

(52) U.S. Cl. CPC G06Q 30/06
USPC 705/26.1

(57) ABSTRACT

The invention relates to a power providing managing unit configured to select a power provider among a plurality of power providers, the selected power provider providing electric power to a power consumer of a user. The power managing unit comprises an interface configured to receive a request for providing electric power to the power consumer, the request containing information about power constraints of the power consumer of the user, and a control unit configured to select a power provider for the power consumer from the plurality of power providers. The control unit is configured to select the power provider taking into account the information about the power constraints of the power consumer.

### PRIORITY CLAIM

The application claims priority to European Patent Application EP1195027.5 filed on Dec. 21, 2011.

### TECHNICAL FIELD

The present invention relates to a power providing managing unit configured to select a power provider and to a method for selecting the power provider.

### BACKGROUND

Since the liberation of the electricity market in many countries, the production of electricity and the distribution are decoupled meaning that the producer of electricity sells its kilowatt hours at a stock exchange and whoever has a contract with end customers can buy these kilowatt hours and sell them to their end customers.

For the end customers changing contracts is normally a lengthy process that requires termination of the current contract and a period of several months before the new contract can become effective. Power providers must provide exactly the quantity of energy they committed to. An overbalance or a shortage lead usually to a penalty. In a power grid there should be always a balance between production and of consumption. Power providers cannot sell electricity at an extra cheap price to end customers on occasion, they can only trade it with other suppliers or industrial consumers like companies running factories with high power demand. The introduction of variable renewable energy sources, such as windmills and solar panels, makes power production unpredictable and keeping the balance between the consumption and the generation is challenging.

Furthermore, different power providers may have different traffic profiles during the day, so that at a certain time of the day the first power provider may be able to provide the power to an end consumer at a better price and more reliably to the consumer than another power provider, whereas in the afternoon the situation may have changed. A concept where the power consumer can freely select the best offer of one of the power providers is missing.

Furthermore, a power consumer of an end user may have different needs. By way of example, when recharging a battery of an electric vehicle, or running a dishwasher, overnight, the stability of the provided power may be less important, meaning that an interruption for a short period of time or for e.g. five minutes may be tolerable, whereas for another power consumer, such as an oven, the interruption of the provided electric power may not be tolerable.

### SUMMARY

Accordingly, a need exists to be able to flexibly select a power provider taking into account the needs of a power consuming entity.

This need is met by the features of the independent claims. Further embodiments are described in the dependent claims.

According to a first aspect of the invention, a power providing managing unit is provided configured to select a power provider among a plurality of power providers, the selected power provider providing electric power to a power consumer of a user. The power managing unit comprises an interface configured to receive a request for providing electric power to the power consumer, the request containing information about power constraints of the power consumer of the user. Furthermore, a control unit is provided configured to select a power provider for the power consumer from the plurality of power providers for the request, wherein the control unit is configured to select the power provider taking into account the information about the power constraints of the power consumer.

The power providing managing unit can flexibly react to a power request made by a user for a power consumer of the user and can select the best power provider which also meets the power constraints of the power consumer.

The power constraints may contain information about whether power to be provided to the power consumer needs to be provided without interruption for a predefined period of time. The control unit may then be configured to select the power provider taking into account this information whether the power to be provided needs to be provided without interruption or not. A further power constraint may be over which period of time a certain amount of electrical power (kilowatt) should be provided. By way of example, when a battery needing a certain amount of kilowatt hours for recharging should be recharged, the power constraints can contain information in which period of time the needed kilowatt hours need to be provided. By way of example, if it is possible to recharge the battery over a longer period of time, e.g. ten hours, than over a short period of time, e.g. two hours, then less power per time unit is needed. If the energy provider knows that a certain amount of kilowatt hours is needed by the power consumer and if the power constraints contain a time indication, the power providing managing unit knows that less current will be drawn when the power consumer is recharged over a longer period of time compared to a situation where it is recharged over a shorter period of time where a higher current and, thus, a higher power per time is needed.

It is possible that the received request for providing to the power consumer is a request for providing power to the power consumer for a defined use case of the power consumer, wherein the control unit is configured to limit the power provided to the power consumer to the time span determined by the defined use case. This solution enables the consumer to choose the power provider in a very flexible and ad hoc way as the power provider is selected depending on the use case of the power consumer.

Furthermore, it is possible that the interface is configured to receive real-time, or time-of-use, pricing information from the different power providers. The control unit can then select the power provider taking into account the real-time pricing information of the different power providers. In this embodiment the control unit can, based on the power constraints and on the pricing information, select the power provider providing the best offer. This best offer can be the offer meeting the power constraints and providing the cheapest price.

Furthermore, it is possible to take into account user requirements for the power to be provided. In this situation, the control unit selects the power provider taking into account the information about the user requirements. One possible user requirement is an indication how the power provided to the power consumer is generated. The user may wish that the power provided by the power provider has been generated using a certain energy source, e.g. using solar energy or wind energy. The control unit can then select the power provider taking into account this information when selecting a power provider for the power consumer.

Additionally, it may be possible that in a certain location, e.g. in a public building or a private house, that several power meters are provided. The control unit can be configured to select the power provider per power meter provided. In a public place different current sources may be provided which are connected to different power meters. One current source may be used to recharge a battery of an electric vehicle, whereas another current source may be provided to recharge a battery of a mobile phone, or a medical breathing device or heart beat monitor. For these different use requirements, different power providers may provide different offers for the provided electric energy. Thus, it may be possible to select the power provider individually for different power meters.

The power providing managing unit may further contain a user identification unit identifying the user of the power consumer. If the user of a power consumer can be identified per use case it is possible to authenticate the user and to charge the user for the use case. One possibility of identifying the user is that the user identification unit identifies the user of the power consumer by the cellular phone of the user. With the cellular phone, the user, the subscriber of the cellular phone, can be identified unambiguously. As a consequence, it is possible to charge a user for the electric energy used by the power consumer. However, it is possible that the user identification unit uses other means, such as the credit card or any other ID allowing identification of the user for charging purposes. The control unit may further be configured to enforce the provision of the power provided by the power provider, e.g. the control unit may be configured to switch off the power provided to the power consumer.

The power providing managing unit may furthermore contain a database for storing the power constraints of the power consumer and/or a database for storing user requirements for the power to be provided. These databases may be provided physically in the power providing managing unit, or may be provided elsewhere accessible by the power providing managing unit, e.g. accessible via the internet. The request can contain an identifier allowing the power consumer to be identified. Based on the identified consumer, the power constraints and/or user requirements can be deduced from the database. In another embodiment the information about the power constraints and/or the user requirements are contained in the request received by the power providing managing unit.

The invention furthermore relates to a method for selecting a power provider among a plurality of power providers, the method comprising the step of receiving a request for providing the electric power to the power consumer. The request contains information about the power constraints of the power consumer of the user. According to another step, the power provider from the plurality of power providers is selected for the request taking into account the information about the power constraints.

As mentioned in more detail above, the power provider may be selected taking into account the different pieces of information discussed above, e.g. the user preference about the generation of the power, time constraints, pricing information etc. Furthermore, it is possible that the request for providing power is received from a power agent. The information about the power constraints is then requested from a first database and the information about the selected power provider meeting the power constraints is then transmitted back to the power agent. The power agent may be located at the user or somewhere accessible to the user and the power providing managing unit. By way of example, the user agent may be a server accessible through the internet.

### BRIEF DESCRIPTION OF THE DRAWINGS

The invention will be described in further detail below with reference to the accompanying drawings, in which

FIG. 1 is a schematic view of how a power providing managing unit selects a power provider for a power consumer,

FIG. 2 shows the exchange of information for selecting a power provider in the embodiment shown in FIG. 1, and

FIG. 3 is a schematic view showing the different pieces of information allowing the power providing managing unit to select a power provider.

### DETAILED DESCRIPTION

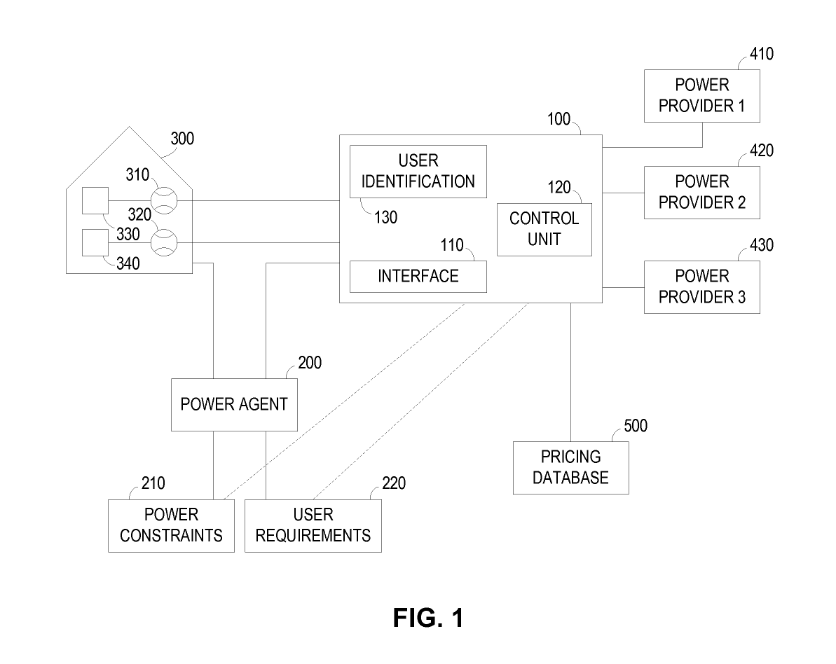

In FIG. 1 a power providing managing unit 100 is schematically shown which is able to select a power provider among a plurality of power providers 410-430 for a power consumer such as power consumers 330, 340.

With the system shown in FIG. 1 a power consumer can choose its power provider in a very flexible and ad hoc way. The user of the power consumers 330 and 340 are schematically shown as being provided in a consumer's home 300. However, it should be understood that the power consumers 330 and 340 may be provided in public places such as a shopping mall or a gas station. The power consumer can be a consumer having a comparably high power consumption such as electric ovens, laundry machines, electric cars. In the embodiment shown in FIG. 1 different power meters 310 and 320 are provided, the power meter metering the power needed by the power consumer. When an end user plans to use one or more power consumers 330, 340, or on a regular basis, a request for the best offer is transmitted to a power agent 200. The power agent 200 can make an estimation about the amount of energy to be consumed. Furthermore, it has access to a database 210, containing the power constraints of the power consumer, and to a database 220, containing the user requirements. In the embodiment shown the power agent is shown as a separate entity. However, it is also possible that the power agent is incorporated into the user's home. In another embodiment it is a separate entity accessible by the user, e.g. via wireless or wired communication services e.g. using the internet. The databases with the power constraints and user requirements 210 and 220 may be updated by the user of the power consumer. By way of example, the users may specify that the electric current to be provided by the power provider has to be provided for a certain use case without interruption, or it can be identified at which rate the required electric energy is drawn from the power provider. In the database of the user requirements 220 the user may indicate that a certain source of energy, e.g. “green energy” such as solar energy or wind energy, is preferred, nuclear energy or the energy generated by burning fossil fuels. Database 210 contains information about the device properties of the devices for which the power is provided, whereas database 220 contains information like user preferences.

The power providing managing unit contains an interface 110 where the request for the power consumption is received, the request indicating the power constraints and/or user requirements. The power providing managing unit 100 furthermore has access to a pricing database 500 where real-time price information of the different power providers 410-430 is provided. A control unit 120 controls the functioning of the power providing managing unit and selects inter alia one of the power providers for a request taking into account the power constraints, user requirements and/or pricing information.

The power providing managing unit may have written contracts with every power provider that wants to take part in this ad hoc provision method. Furthermore, it is possible that the power providing managing unit enforces payment, meaning that it has the right to switch off the power to a power consumer when the consumer uses a post-pay method. The power provider may also provide a pre-paid scheme which is useful in the case of provisioning power in public places like malls. To be able to charge the user for the used power, a user identification unit 130 is provided. The user identification unit may use the power meter 310, 320 to identify the user, or in public places may use any other possibility to identify a user, e.g. the consumer's mobile phone or a credit card of a user. When the power meter 310, 320 is provided in a public place and is used to recharge an electric vehicle, a vehicle ID or a mobile phone used in the vehicle may be used to identify the user. However, it is also possible that in a private home the consumer's mobile phone is used for authentication. This has the advantage that the power meter in a private home may also be used by a visiting person, e.g. for charging an electric car when visiting a friend. To distinguish different electrical consumer loads several power meters, such as the meters 310 and 320, may be installed, e.g. one dedicated for recharging an electric vehicle, the other for the rest of the household. The power providing managing unit can select the power provider per power meter.

It is possible that different power consumers may have different power constraints. For some applications, like ovens, it is necessary to receive the power uninterrupted. In another case, it may be tolerable if the power is interrupted, e.g. when charging a battery overnight. When requesting the need for a power provider, the user may indicate the amount of kilowatt hours needed for a use case, and the power providing managing unit then selects the optimum power provider.

The billing information exchanged between the user and the power providing managing unit can contain data records that contain the identification of the consumer and the identification of the electricity provider. Furthermore, the beginning and the end of the consumption from the chosen power provider can be indicated. A record may be sent to the user's home, e.g. once a day, and this record may contain a summary of the day's consumption. This record or billing information may also be sent every time the power provider is changed.

As mentioned above, the power providing managing unit can provide power from different power providers for different power meters.

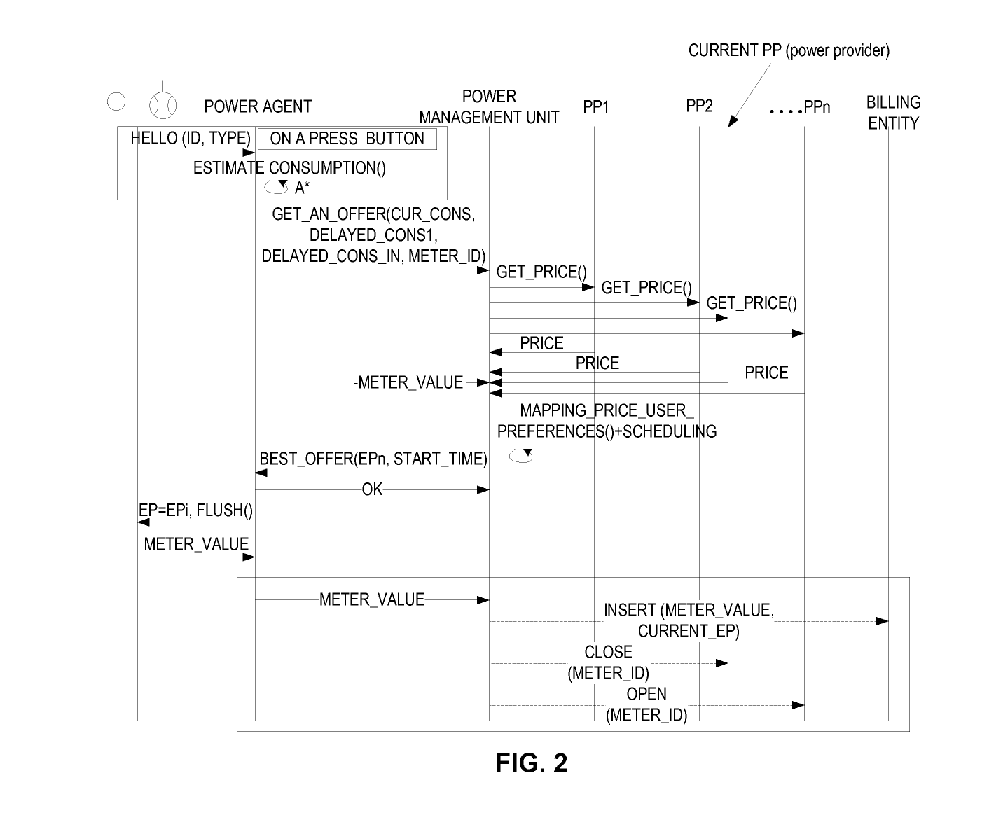

In the embodiment of FIG. 2, the flow for selecting a power provider is explained in more detail.

A user or the power consumer itself initiates a request to the power agent 200. The power agent then determines the power constraints and/or user requirements and in the next step a request for an offer is sent to the power providing managing unit. The information about the power constraints or user requirements may be contained in the request received from the user. In another embodiment, the power agent identifies the power consumer and the user by the request and retrieves the information about power constraints and user requirements from the corresponding databases 210 and 220. The power providing managing unit then receives the request and checks the pricing information from the different participating power providers. The power providing managing unit requests the pricing information from the different power providers, e.g. by accessing the real-time pricing database 500. Furthermore, the power providing managing unit checks whether the user requirements and power constraints are met by the different power providers. The information about how the power is generated may also be requested from the different power providers in order to meet the corresponding user requirement. The power providing managing unit then selects the best offer taking into account the user preferences, the time constraints, whether the provision of power can be deferred or interrupted. The power agent then acknowledges the selection of the best offer.

The electric energy is then fed directly through the power providing managing unit to the power meters at the user (not shown in FIG. 2).

When the time to execute the best offer is reached, the managing unit informs the current power provider that the provision of power can be terminated to switch to the best offer provider.

In the embodiments described above, information about the power constraints and user requirements were contained in the request transmitted from the power agent to the power providing managing unit. However, it is also possible that the required information is not contained in the request. As indicated by the dashed lines in FIG. 1, the power providing managing unit may also directly access the databases containing the power constraints and user requirements.

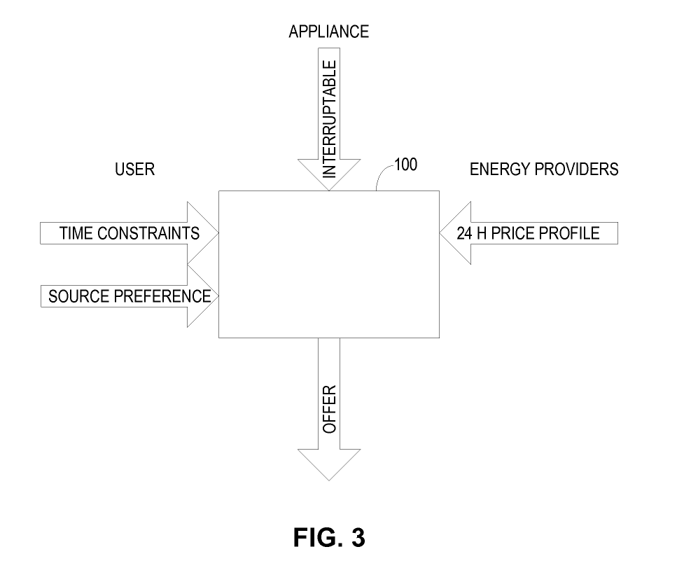

In FIG. 3 it is schematically shown how the selection of the best offer is carried out by the power providing managing unit, the selection decision is based on information regarding the user and his/her preferences such as a preference for “green” power, preferences for the use case to be finished. For example, this may mean that the user preferences contain the information that the use case should be finished at a certain point in time at the latest. The power providing managing unit further receives the information about the power constraints. Furthermore, the information about the power provider is received containing information about the type of source used by the power provider and a price profile. The price profile can contain real-time pricing information or time-of-use pricing information. The actual implementation of the algorithm to select the best offer can be achieved in many different ways. One example could be by means of a weighted sum, each piece of information, such as the power constraints and user preferences, is given a certain weight and the power provider for which the highest value is obtained is offered to the user.

1. A power providing managing unit configured to select a power provider among a plurality of power providers, the selected power provider providing electric power to a power consumer of a user, the power managing unit comprising:
an interface configured to receive a request for providing electric power to the power consumer, the request containing information about power constraints of the power consumer of the user,
a control unit configured to select a power provider for the power consumer from the plurality of power providers for the request, wherein the control unit is configured to select the power provider taking into account the information about the power constraints of the power consumer.

2. The power providing managing unit according to claim 1, wherein the interface is further configured to receive real-time pricing information from the plurality of power providers, the control unit being configured to select the power provider taking into account the real-time pricing information.

3. The power providing managing unit according to claim 1, wherein the request contains information about user requirements for the power to be provided to the power consumer, the control unit being configured to select the power provider taking into account the information about the user requirements.

4. The power providing managing unit according to claim 3, wherein the user requirements contain an indication how the power provided to the power consumer by the power provider should have been generated, the control unit being configured to select a power provider taking into account the indication

5. The power providing managing unit according to claim 1, wherein the control unit is configured to select the power provider per power meter provided at the user.

6. The power providing managing unit according to claim 1, wherein the power constraints contain information about whether power to be provided to the power consumer needs to be provided without interruption for a predefined period of time, wherein the control unit is configured to select the power provider taking into account the fact whether the power to be provided needs to be provided without interruption or not.

7. The power providing managing unit according to claim 1, further comprising a user identification unit configured to identify the user of the power consumer.

8. The power providing managing unit according to claim 7, wherein the user identification unit identifies the user of the power consumer by a cellular phone of the user.

9. The power providing managing unit according to claim 1, further comprising a first database storing the power constraints of the power consumer.

10. The power providing managing unit according to claim 3, further comprising a second database storing the user requirements for the power to be provided.

11. The power providing managing unit according to claim 1, wherein the control unit is configured to switch off the power provided to the power consumer of the user by the selected power provider.

12. The power providing managing unit according to claim 1, wherein the received request for providing power to the power consumer is a request for providing power to the power consumer for a defined use case of the power consumer, wherein the control unit is configured to limit the power provided to the power consumer to a time span determined by the defined use case.

13. A method for selecting a power provider among a plurality of power providers, the selected power provider providing electric power to a power consumer of a user, the method comprising the steps of
receiving a request for providing the electric power to the power consumer, the request containing information about power constraints of the power consumer of the user,
selecting a power provider from the plurality of power providers for the request, wherein the power provider is selected taking into account the information about the power constraints.

14. The method according to claim 13, wherein the received request contains information about user requirements for the power to be provided to the power consumer, the power provider being selected taking into account the information about the user requirements.

15. The method according to claim 13, wherein the request for providing power is received from a power agent,
requesting the information about power constraints of the power consumer from a first database,
transmitting information about the selected power provider meeting the power constraints to the power agent.

16. The method according to claim 13, wherein the request is received for each use case of the power consumer, wherein the selected power provider is selected for a time span defined by the use case.
